(19) United States
(12) Patent Application Publication
(10) Pub. No.: US 2004/0190687 A1
(43) Pub. Date: Sep. 30, 2004

(54) Speech recognition assistant for human call center operator

(75) Inventor: James K. Baker, Maitland, FL (US)

Correspondence Address: FOLEY AND LARDNER, SUITE 500, 3000 K STREET NW, WASHINGTON, DC, 20007, US

(73) Assignee: Aurilab, LLC

(21) Appl. No.: 10/396,427

(22) Filed: Mar. 26, 2003

(51) Int. Cl. H04M 1/64; H04M 3/00

(52) U.S. Cl. 379/88.01; 379/265.02

(57) ABSTRACT

A method for interpreting information provided over a telephone line from a customer includes providing at least a portion of an utterance made by the customer to a speech recognizer, at a same time the utterance is being heard on the telephone line by a call center operator. The method also includes processing, by the speech recognizer, the portion of the utterance made by the customer, in order to obtain a speech recognition result. The method further includes providing the speech recognition result to the call center operator, to assist the call center operator in discerning the utterance made by the customer.

### DESCRIPTION OF THE RELATED ART

For conventional call center systems and methods, a customer calls a particular telephone number of a call center in order to either consummate a transaction or to obtain information. For example, a customer may want to know if a particular product of a company is currently in stock, as well as other information on the product. As another example, the customer may have received a catalog from a company, and has called the call center (whose number is listed in the catalog) in order to purchase one or more products described in the catalog.

In conventional call center systems, a human call center operator answers the telephone call made by the customer, and assists the customer based on what the customer wants done. If the customer wants to purchase a product, for example, the human call center operator obtains personal information from the customer, such as the customer's full name, address, and credit card information, so that the desired product can be shipped to the customer and the customer can be charged for the purchase made via the call center.

Call centers, like other companies, strive for efficiency. In this regard, there may occur inefficiencies with respect to human call center operators understanding the audible information that the customer has provided over a telephone line. For example, the sound of “s” and “f” is hard to distinguish over a telephone line, and a human call center operator may mistake an “s” sound for an “f” sound of an utterance made by the caller, or vice versa, which could lead to the caller being provided with incorrect information, or having to lengthen the call time between the human call center operator and the customer as the customer has to repeat something that he or she said, so that the human call center operator can correctly discern the caller's utterance. Also, in cases where the caller has an accent (e.g., foreign accent or Southern U.S. accent), and/or in cases where a first and/or last name spoken by the caller is unusual, the human call center operator may not have correctly discerned the information provided by the caller.

As one may guess, this can result in unhappy customers who have to repeat portions of their utterances due to their utterances not be correctly understood the first time, and/or a longer average transaction time for a human call center operator to handle a request made by a caller.

The present invention is directed to overcoming or at least reducing the effects of one or more of the problems set forth above.

### SUMMARY OF THE INVENTION

According to one embodiment of the invention, there is provided a method for interpreting information provided over a telephone line from a customer. The method includes a step of providing at least a portion of an utterance made by the customer to a speech recognizer, at a same time the utterance is being heard on the telephone line by a call center operator. The method further includes a step of processing, by the speech recognizer, the portion of the utterance made by the customer, in order to obtain a speech recognition result. The method also includes a step of providing the speech recognition result to the call center operator, to assist the call center operator in discerning the utterance made by the customer.

In one possible implementation, the speech recognition result is provided as a textual display on a computer monitor. In another possible implementation, the speech recognition result is provided as an audible display to the call center operator.

In another embodiment of the invention, there is provided a system for deciphering an utterance made by a caller over a telephone line. The system includes a recording unit configured to record an utterance of the caller. The system also includes a speech recognition processing unit configured to receive the recorded caller's utterance form the recording unit and to perform speech recognition processing on the caller's recorded utterance, in order to obtain a speech recognition result. The system further includes providing means for providing the recorded caller's utterance and the speech recognition result, as a set of information, to a human call center operator, in order to allow the human call center operator to correctly decipher the caller's utterance.

In yet another embodiment of the invention, there is provided a method for deciphering a caller's utterance made over a telephone line. The method includes recording the caller's utterance. The method also includes performing speech recognition processing on the caller's recorded utterance, in order to obtain a speech recognition result. The method further includes providing the recorded caller's utterance to a human call center operator, along with the speech recognition result, as a set of information, in order assist the human call center operator in deciphering the caller's utterance.

According to another embodiment of the invention, there is provided a system for deciphering a caller's utterance made over a telephone line. The system includes a recording unit configured to record the caller's utterance. The system also includes a speech recognition processing unit configured to receive the recorded caller's utterance form the recording unit and to perform speech recognition processing on the caller's recorded utterance, in order to obtain a speech recognition result. The system further includes a providing unit for providing the recorded caller's utterance and the speech recognition result, as a set of information, to a human call center operator, along with the speech recognition result, as a set of information, in order assist the human call center operator in deciphering the caller's utterance.

### BRIEF DESCRIPTION OF THE DRAWINGS

The foregoing advantages and features of the invention will become apparent upon reference to the following detailed description and the accompanying drawings, of which:

FIG. 1 is a block diagram of a call center assistant system according to a first embodiment of the invention;

FIG. 2 is a flow chart of a call center assistant method according to the first embodiment of the invention;

FIG. 3 is a block diagram of a call center assistant system utilized for a telephone information call center, according to a third embodiment of the invention; and

FIG. 4 is a flow chart of a call center assistant method utilized for a telephone information call center, according to the third embodiment of the invention.

### DETAILED DESCRIPTION OF SPECIFIC EMBODIMENTS

The invention is described below with reference to drawings. These drawings illustrate certain details of specific embodiments that implement the systems and methods and programs of the present invention. However, describing the invention with drawings should not be construed as imposing, on the invention, any limitations that may be present in the drawings. The present invention contemplates methods, systems and program products on any computer readable media for accomplishing its operations. The embodiments of the present invention may be implemented using an existing computer processor, or by a special purpose computer processor incorporated for this or another purpose or by a hardwired system.

As noted above, embodiments within the scope of the present invention include program products comprising computer-readable media for carrying or having computer-executable instructions or data structures stored thereon. Such computer-readable media can be any available media which can be accessed by a general purpose or special purpose computer. By way of example, such computer-readable media can comprise RAM, ROM, EPROM, EEPROM, CD-ROM or other optical disk storage, magnetic disk storage or other magnetic storage devices, or any other medium which can be used to carry or store desired program code in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such a connection is properly termed a computer-readable medium. Combinations of the above are also be included within the scope of computer-readable media. Computer-executable instructions comprise, for example, instructions and data which cause a general purpose computer, special purpose computer, or special purpose processing device to perform a certain function or group of functions.

The invention will be described in the general context of method steps which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represent examples of corresponding acts for implementing the functions described in such steps.

The present invention in some embodiments, may be operated in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a conventional computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to removable optical disk such as a CD-ROM or other optical media. The drives and their associated computer-readable media provide nonvolatile storage of computer-executable instructions, data structures, program modules and other data for the computer.

The following terms may be used in the description of the invention and include new terms and terms that are given special meanings.

“Speech element” is an interval of speech with an associated name. The name may be the word, syllable or phoneme being spoken during the interval of speech, or may be an abstract symbol such as an automatically generated phonetic symbol that represents the system's labeling of the sound that is heard during the speech interval.

“Priority queue” in a search system is a list (the queue) of hypotheses rank ordered by some criterion (the priority). In a speech recognition search, each hypothesis is a sequence of speech elements or a combination of such sequences for different portions of the total interval of speech being analyzed. The priority criterion may be a score which estimates how well the hypothesis matches a set of observations, or it may be an estimate of the time at which the sequence of speech elements begins or ends, or any other measurable property of each hypothesis that is useful in guiding the search through the space of possible hypotheses. A priority queue may be used by a stack decoder or by a branch-and-bound type search system. A search based on a priority queue typically will choose one or more hypotheses, from among those on the queue, to be extended. Typically each chosen hypothesis will be extended by one speech element. Depending on the priority criterion, a priority queue can implement either a best-first search or a breadth-first search or an intermediate search strategy.

“Frame” for purposes of this invention is a fixed or variable unit of time which is the shortest time unit analyzed by a given system or subsystem. A frame may be a fixed unit, such as 10 milliseconds in a system which performs spectral signal processing once every 10 milliseconds, or it may be a data dependent variable unit such as an estimated pitch period or the interval that a phoneme recognizer has associated with a particular recognized phoneme or phonetic segment. Note that, contrary to prior art systems, the use of the word “frame” does not imply that the time unit is a fixed interval or that the same frames are used in all subsystems of a given system.

“Stack decoder” is a search system that uses a priority queue. A stack decoder may be used to implement a best first search. The term stack decoder also refers to a system implemented with multiple priority queues, such as a multi-stack decoder with a separate priority queue for each frame, based on the estimated ending frame of each hypothesis. Such a multi-stack decoder is equivalent to a stack decoder with a single priority queue in which the priority queue is sorted first by ending time of each hypothesis and then sorted by score only as a tie-breaker for hypotheses that end at the same time. Thus a stack decoder may implement either a best first search or a search that is more nearly breadth first and that is similar to the frame synchronous beam search.

“Modeling” is the process of evaluating how well a given sequence of speech elements match a given set of observations typically by computing how a set of models for the given speech elements might have generated the given observations. In probability modeling, the evaluation of a hypothesis might be computed by estimating the probability of the given sequence of elements generating the given set of observations in a random process specified by the probability values in the models. Other forms of models, such as neural networks may directly compute match scores without explicitly associating the model with a probability interpretation, or they may empirically estimate an a posteriori probability distribution without representing the associated generative stochastic process.

“Grammar” is a formal specification of which word sequences or sentences are legal (or grammatical) word sequences. There are many ways to implement a grammar specification. One way to specify a grammar is by means of a set of rewrite rules of a form familiar to linguistics and to writers of compilers for computer languages. Another way to specify a grammar is as a state-space or network. For each state in the state-space or node in the network, only certain words or linguistic elements are allowed to be the next linguistic element in the sequence. For each such word or linguistic element, there is a specification (say by a labeled arc in the network) as to what the state of the system will be at the end of that next word (say by following the arc to the node at the end of the arc). A third form of grammar representation is as a database of all legal sentences.

“Stochastic grammar” is a grammar that also includes a model of the probability of each legal sequence of linguistic elements.

The present invention according to at least one embodiment is directed to a human call center assistance method and system, which reduces the number of errors made by a human call center assistant with regards to properly interpreting information uttered by a caller over a telephone line.

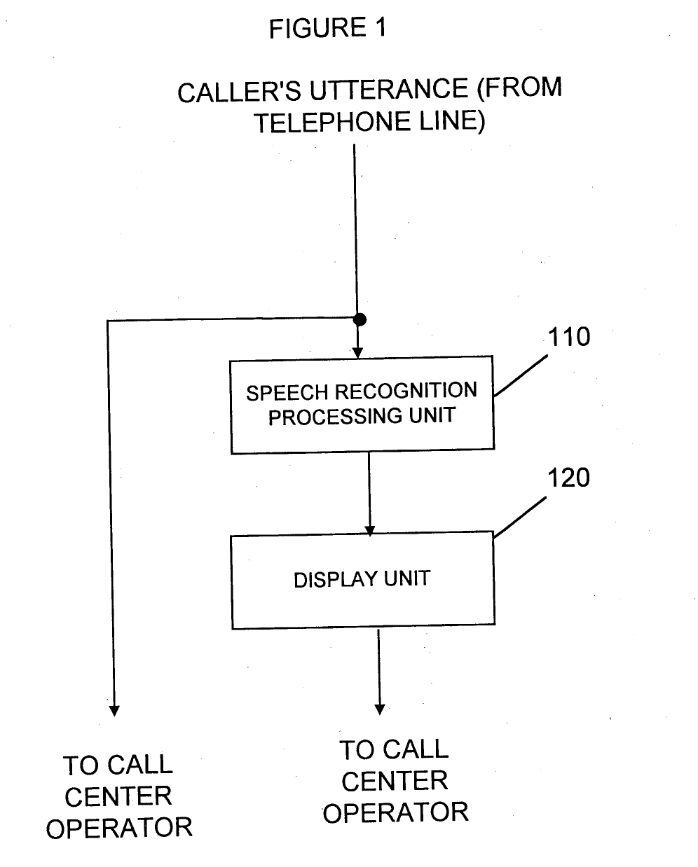

In a first embodiment, as shown in block diagram form in FIG. 1, a human call center operator receives a telephone call from a customer. That telephone call may be for a variety of purposes, such as: a) the customer attempting to purchase a product or service that the customer found out about by other means (e.g., catalog mailed to the customer; information obtained via Internet surfing by the customer, etc.), b) the customer trying to find out more information as to a product or service or to get help with regards to a product or service purchased by the customer (e.g., a call center that deals with assisting customers in assembling products that are sold unassembled in stores), or c) the customer trying to obtain desired information (e.g., calling a telephone number assistance call center to obtain a telephone number of a person whom the customer wants to call).

In FIG. 1, when the human call center operator answers a telephone call made by a customer, a speech recognizer unit 110 receives all utterances made by the customer over the telephone line. The customer's utterances are processed by the speech recognizer unit 110 in a manner known to those skilled in the art, and a speech recognition output is provided to a display unit 120. In a preferred implementation of the first embodiment, the display unit 120 displays the speech recognition output textually on a computer monitor, so that the human call center operator can review the speech recognition output at substantially the same time the human call center operator is listening to that same speech made by the customer over the telephone line. Accordingly, the human call center operator will make less errors in discerning the caller's utterance, based on the speech recognition “assistant”, and thus this embodiment provides for a customer's experience that is at least as good as, and likely in many cases better than, conventional systems which rely on human operators alone to interpret the customer's utterances.

By way of example, as a customer is uttering his first name, last name, and address to the human call center operator, such as when the customer has decided to make a purchase of a product via the call center and thus has to provide his or her personal information, the operator may have not understood the customer's utterance of his or her address, and/or the operator may have understood it but is unable to spell it correctly (and thus cannot enter that data correctly into a product ordering database at the call center). In that case, the operator only has to review the portion of the speech recognition output corresponding to the caller's utterance of his or her address, to see if the operator can discern it based on this additional information. If the operator can discern the caller's utterance based on the additional speech recognition output information, then the operator can then request other information from the customer (e.g., obtain the customer's credit card number after having obtained the customer's name and address information), and/or complete the call. If the operator cannot discern the caller's utterance based on the operator having heard the caller and based on the additional speech recognition output information, then the operator may have to request that the customer repeat a portion of his or her utterance that has not been understood by the operator (even with the assistance of the speech recognizer).

In the first embodiment, the “speech recognition assistant” is an unobtrusive listener to a telephone conversation between a human call center operator and a customer, and the customer acts just the same as if the customer were talking just to the human operator (except for being informed that the call may be monitored or recorded). Accordingly, the first embodiment works at least as well as conventional call center systems and methods that rely on human operators alone to discern a caller's utterance.

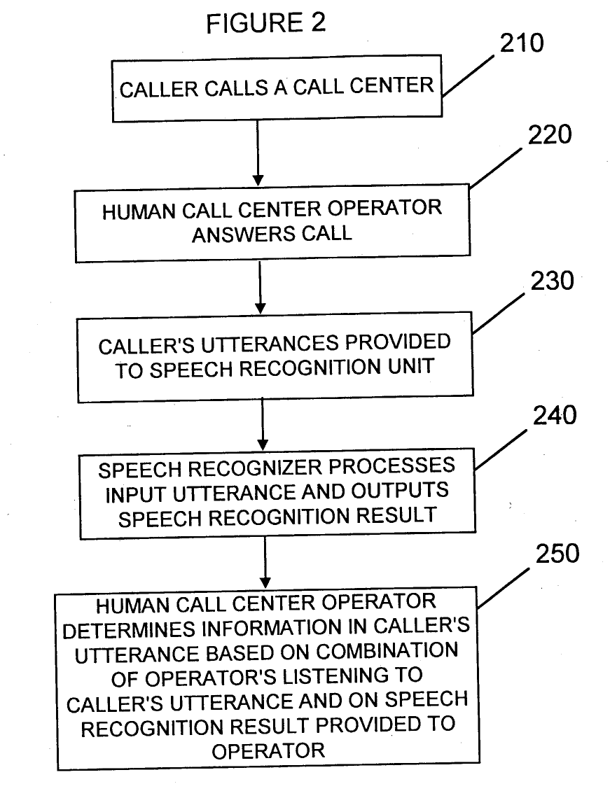

FIG. 2 shows operation of the first embodiment in flow diagram form. In a first step 210, a caller calls a call center. In a second step 220, a human call center operator answers the call made by the caller. In a third step 230, all utterances made by the caller over the telephone line are provided to a speech recognizer. In a fourth step 240, the speech recognizer provides a speech recognition output with respect to the caller's input speech provided to the speech recognizer. In a fifth step 250, the human call center operator is provided with the speech recognition output either textually or audibly, or both, at substantially the same time (e.g., a few milliseconds after) that the operator has heard the caller's utterance, so that the human call center operator can determine whether or not he or she has correctly understood what the caller has spoken over the telephone line, with the assistance provided by the speech recognizer.

In a second embodiment, when a call is made to a call center, a speech recognizer does not automatically receive all utterances made by the caller. Rather, based on the human call center operator's determination as to how well the operator can understand the caller, the operator may decide that the “speech recognition assistant” is not necessary. In that case, the operator assists the customer without assistance of a speech recognizer. However, in cases where the operator feels that he or she will need assistance from the speech recognizer, based on the caller's accent, for example, then the operator initiates the speech recognition assistant to process the caller's utterances. This initiation by the operator may be made by any of a variety of ways, such as by the operator clicking on an icon on a computer monitor of the operator to activate an application program to be run by the computer, whereby the application program initiates the speech recognition assistant.

The first embodiment has been described with reference to a general call center interaction between a caller and a human call center operator.

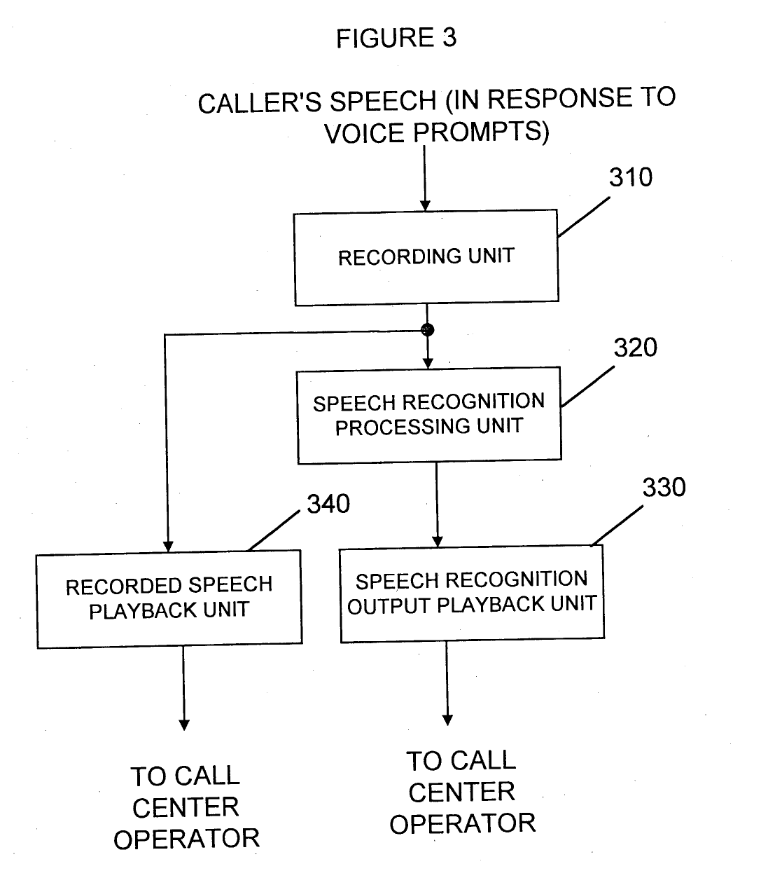

In a third embodiment, a speech recognition assistant may be used in a partially automated call center operation, such as when a caller calls a telephone directory assistance telephone number to obtain a desired telephone number of a person whom the caller desires to call. As shown in block diagram form in FIG. 3, a recording unit 310 records speech from a caller over a telephone line, whereby the recording unit 310 records portions of a caller's speech that occur after the caller is prompted to speak particular information, such as “city and state of a callee” or “first name and last name of a callee”. The speech recorded by the recording unit 310 is provided to a speech recognition unit 320. The speech recognition unit 320 performs speech recognition of the caller's speech (that is, speech elements of the caller's speech are processed based on a grammar and language model utilized by the speech recognition unit 320), in a manner known to those skilled in the art. The output of the speech recognition unit 320, which may be a phonetic sequence, a phonetic lattice, or a word sequence, for example, is provided to speech recognition playback unit 330. The speech recognition playback unit 330 provides the speech recognition output to the human call center operator in a manner that allows the human call center operator to easily review the speech recognition output of the speech recognition unit 320. By way of example and not by way of limitation, the speech recognition playback unit 330 may provide the output of the speech recognition unit 320 as either a textual output on a monitor of a personal computer, and/or provide the output of the speech recognition unit 320 to an audio output unit (e.g., by way of a speaker) so that the human call center operator can hear the speech recognition output.

Concurrently with the providing of the speech recognition output to the human call center operator, the output of the recording unit 310 is provided to the human call center operator by way of a recorded speech playback unit 340. The recorded speech playback unit 340 provides the recorded speech of the caller to the human call center operator in an audible manner, so that the human call center operator can hear the city, state, first name and last name of the person for whom the caller wants a telephone number. In the preferred embodiment, the recorded speech of the caller is audibly provided to the human call center operator, at the same time or substantially the same time as when the output of the speech recognition unit 330 is textually displayed to a computer monitor of the human call center operator.

By way of the third embodiment, whereby both the human call center operator and a speech recognition assistant “listen to” (and thereby process) a caller's utterance at the same time, the human call center operator is provided with additional information from the speech recognition unit 330 in order that the human call center operator will be able to make a proper query to a telephone directory database. The output of the speech recognition unit 330 may confirm that the human call center operator properly understood the caller's utterance, or it may conflict with the human call center operator's understanding of the caller's utterance. In the latter case, the human call center operator may then personally talk to the caller on the telephone line, in order to determine exactly what the caller had said in response to one or both of the voice prompts.

There may be cases where the speech recognition output does not match what the human call center operator thinks the caller said, but whereby the human call center operator is certain that his or her understanding of the caller's utterance is correct. In these cases, the speech recognition output does not help the human call center operator, but it also does not hinder the human call center operator in performing a proper telephone directory database query.

By way of example of operation of the third embodiment, assume that the caller has a strong Southern accent. When the caller calls into the call center, the caller speaks “Janice Johnson” in response to a first voice prompt. However, due the caller's accent, a human call center operator thinks that she hears “Janet Johnson”. Now, with the speech recognition assistant according to the third embodiment, a speech recognition unit performs speech recognition processing on the caller's utterance, and outputs “Janet Johnson” (whereby the speech recognition unit in this example is tuned to handle heavy Southern accents). The human call center operator then sees the discrepancy between what she thinks she heard and what the speech recognition unit thinks was said by the caller, and thus the human call center operator can take appropriate actions, such as to personally talk to the caller over the telephone line to determine what the caller actually said (e.g., did you say “Janet as in Janet Jackson?”), in order to obtain the correct information from the caller.

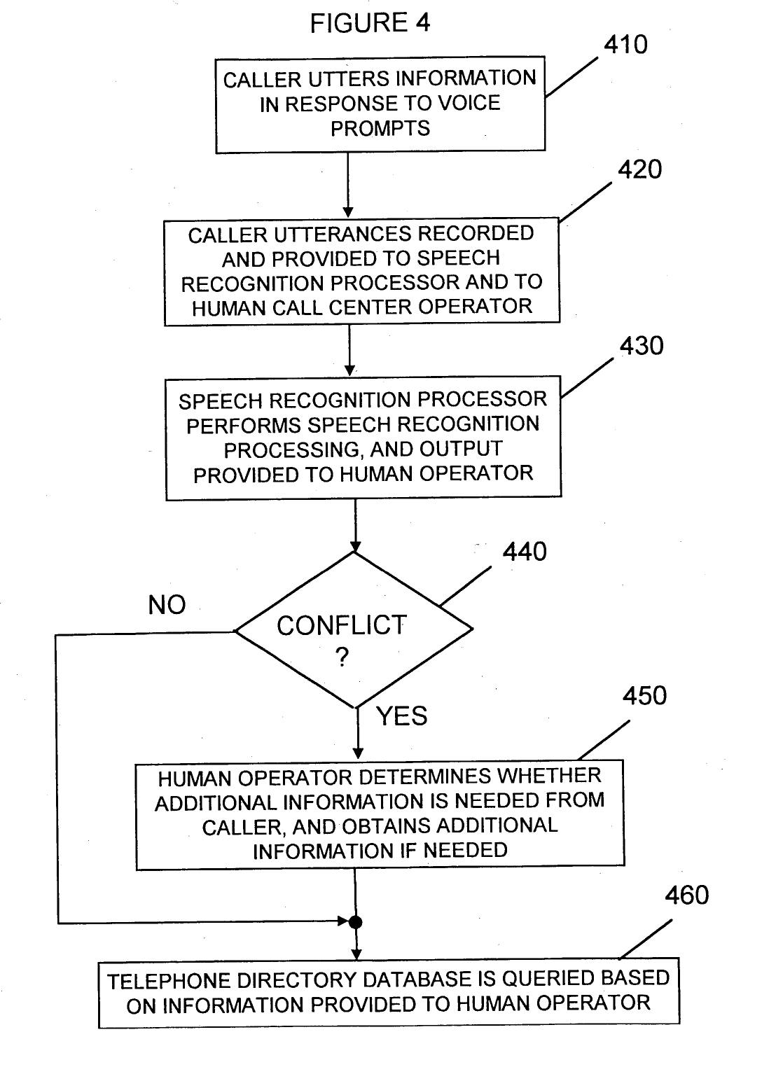

FIG. 4 is a flow chart showing the steps performed by way of a method according to the third embodiment. In step 410, a caller to a telephone directory assistant telephone number utters information in response to one or more voice prompts, whereby that information is with respect to a person or company for whom the caller desires a telephone number.

In step 420, the caller's utterances in response to the prompts is recorded, and also sent to a speech recognition unit.

In step 430, the speech recognition unit performs processing, and the output of the speech recognition unit is provided to the human call center operator, preferably by way of text provided on a display, and at the same time (or just before or after the text is provided on the display), the caller's recorded utterances are audibly provided to the human call center operator.

The human call center operator determines the proper information that the caller provided, based on the recorded information and on the speech recognition output. If there is a conflict between the recorded information and the speech recognition output, as determined in step 440, then the human call center operator determines whether or not to request additional information from the caller. If so (Yes in step 440), then that additional information is requested and obtained from the caller in step 450. In step 460, a query is made to a telephone directory database based on the information provided to the human call center operator, so that the proper telephone number that the caller desires may be obtained from a telephone directory database and thereby provided to the caller.

In a fourth embodiment of the invention, the human call center operator is given the option of having the speech recognition unit analyze the caller's additional information utterance made in the step 450, in order to assist the human call center operator in determining what the caller said. In all other respects, the fourth embodiment is the same as the third embodiment.

It should be noted that although the flow charts provided herein show a specific order of method steps, it is understood that the order of these steps may differ from what is depicted. Also two or more steps may be performed concurrently or with partial concurrence. Such variation will depend on the software and hardware systems chosen and on designer choice. It is understood that all such variations are within the scope of the invention. Likewise, software and web implementations of the present invention could be accomplished with standard programming techniques with rule based logic and other logic to accomplish the various database searching steps, correlation steps, comparison steps and decision steps. It should also be noted that the word “module” or “component” or “unit” as used herein and in the claims is intended to encompass implementations using one or more lines of software code, and/or hardware implementations, and/or equipment for receiving manual inputs.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated. For example, the present invention may be utilized by a call center that obtains purchasing information from a customer, such as credit card information, whereby the speech recognition processor gives the human call center operator an additional aide in determining what the caller has spoken.

Pseudo Code that may be utilized to implement the present invention according to at least one embodiment is provided below:

1) Human operator answers call, speech goes through computer digital file.

2) When caller speaks a name and address, operator activates computer-enabled speech recognition.

3) Database name and address recognition is performed on a database that contains name and address information as well as other information.

4) Output of speech recognition is displayed to operator.

5) If operator detects possibility of error, then operator corrects recognition errors and/or asks caller to repeat or clarify.

6) Name and address information is entered into database as corrected.

What is claimed is:

1. A method for interpreting information provided over a telephone line from a customer, comprising:
a) providing at least a portion of an utterance made by the customer to a speech recognizer, at a same time the utterance is being heard on the telephone line by a call center operator;
b) processing, by the speech recognizer, the portion of the utterance made by the customer, in order to obtain a speech recognition result; and
c) providing the speech recognition result to the call center operator, to assist the call center operator in discerning the utterance made by the customer.

2. The method according to claim 1, wherein the speech recognition result is textually provided to the call center operator.

3. The method according to claim 1, wherein the speech recognition result is audibly provided to the call center operator.

4. The method according to claim 1, further comprising:
prior to the step a), listening to a portion of an utterance made by the caller, and determining whether or not to perform steps a), b) and c) accordingly.

5. A method for deciphering an utterance made by a caller over a telephone line, comprising:
recording an utterance of the caller made over the telephone line;
performing speech recognition processing on the caller's recorded utterance, in order to obtain a speech recognition result; and
providing the recorded caller's utterance to a human call center operator, along with the speech recognition result, as a set of information, in order to allow the human call center operator to decipher the utterance made by the caller based on the set of information.

6. The method according to claim 5, wherein the recorded caller's utterance is provided to the human call center operator at substantially the same time that the speech recognition result is provided to the human telephone directory operator.

7. The method according to claim 5, further comprising:
providing the recorded caller's utterance to the human call center operator way of a first playback unit; and
providing the speech recognition result to the human call center operator by way of a second playback unit.

8. The method according to claim 7, wherein the first playback unit provides the recorded caller's utterance audibly to the human call center operator.

9. The method according to claim 7, wherein the second playback unit provides the recorded caller's utterance visually to the human call center operator by way of text displayed on a display.

10. The method according to claim 8, wherein the second playback unit provides the recorded caller's utterance visually to the human call center operator by way of text displayed on a display.

11. The method according to claim 5, wherein the speech recognition processing is performed by a priority queue search process.

12. The method according to claim 5, wherein the speech recognition processing is performed by a frame synchronous beam search process.

13. A system for deciphering an utterance made by a caller over a telephone line, comprising:
a recording unit configured to record an utterance of the caller;
a speech recognition processing unit configured to receive the recorded caller's utterance form the recording unit and to perform speech recognition processing on the caller's recorded utterance, in order to obtain a speech recognition result; and
providing means for providing the recorded caller's utterance and the speech recognition result, as a set of information, to a human call center operator, in order to allow the human call center operator to correctly decipher the caller's utterance.

14. The system according to claim 13, wherein the providing means provides the recorded caller's utterance to the human call center operator at substantially the same time that the speech recognition result is provided to the human call center operator.

15. The system according to claim 13, wherein the providing means comprises:
a first playback unit for providing the recorded caller's utterance to the human call center operator; and
a second playback unit for providing the speech recognition result to the human call center operator.

16. The system according to claim 13, wherein the first playback unit provides the recorded caller's utterance audibly to the human call center operator.

17. The system according to claim 13, wherein the second playback unit provides the recorded caller's utterance visually to the human call center operator by way of text displayed on a display.

18. The system according to claim 16, wherein the second playback unit provides the recorded caller's utterance visually to the human call center operator by way of text displayed on a display.

19. The system according to claim 13, wherein the speech recognition processing unit performs a priority queue search process on the caller's recorded utterance.

20. The system according to claim 13, wherein the speech recognition processing unit performs a frame synchronous beam search process on the caller's recorded utterance.

21. A program product having machine readable code for deciphering an utterance made by a caller over a telephone line, the program code, when executed, causing a machine to perform the following steps:
recording an utterance made by the caller over the telephone line;
performing speech recognition processing on the caller's recorded utterance, in order to obtain a speech recognition result; and
providing the recorded caller's utterance to a human call center operator, along with the speech recognition result, as a set of information, in order to allow the human call center operator to correctly decipher the caller's utterance.

22. The program product according to claim 21, wherein the recorded caller's utterance is provided to the human call center operator at substantially the same time that the speech recognition result is provided to the human call center operator.

23. The program product according to claim 21, further comprising:
providing the recorded caller's utterance to the human call center operator by way of a first playback unit; and
providing the speech recognition result to the human call center operator by way of a second playback unit.

24. The program product according to claim 21, wherein the first playback unit provides the recorded caller's utterance audibly to the human call center operator.

25. The program product according to claim 21, wherein the second playback unit provides the recorded caller's utterance visually to the human call center operator by way of text displayed on a display.

26. The program product according to claim 25, wherein the second playback unit provides the recorded caller's utterance visually to the human call center operator by way of text displayed on a display.

27. The program product according to claim 21, wherein the speech recognition processing is performed by a priority queue search process.

28. The program product according to claim 21, wherein the speech recognition processing is performed by a frame synchronous beam search process.
